(19) United States
(12) Patent Application Publication
(10) Pub. No.: US 2025/0029598 A1
(43) Pub. Date: Jan. 23, 2025

(54) FINE-GRAINED IN-VEHICLE DYNAMIC NOISE PATTERN LEARNING FOR VOICE APPLICATIONS

(71) Applicant: GM GLOBAL TECHNOLOGY OPERATIONS LLC, Detroit, MI (US)

(72) Inventors: Alaa M. Khamis, Courtice (CA); Xu Fang Zhao, LaSalle (CA); Gaurav Talwar, Novi, MI (US); Kenneth R. Booker, Grosse Pointe Woods, MI (US)

(73) Assignee: GM GLOBAL TECHNOLOGY OPERATIONS LLC, Detroit, MI (US)

(21) Appl. No.: 18/355,685

(22) Filed: Jul. 20, 2023

(51) Int. Cl. G10L 15/06; G10L 21/0224

(52) U.S. Cl. CPC G10L 15/063; G10L 21/0224

(57) ABSTRACT

Aspects of fine-grained, dynamic noise pattern learning for voice applications include a vehicle, the vehicle having a body with a cabin. Embedded within the vehicle is a processor coupled to memory. The processor may be configured to embed multimodal data for environment and vehicle data. The embedded acoustic data may be from microphone-captured data in the cabin. The processor may concatenate the embeddings to form a latent vector characterizing the embeddings to thereby estimate a mean and variance of the latent vector using an adaptive time window. The processor may identify a noise type using the mean and variance of the latent vector, the noise type identification being fine-grained via the adaptive time window to accurately emulate vehicle noise.

### INTRODUCTION

Existing techniques for in-vehicle noise suppression used with voice-based applications, such as speech recognition, are often limited in scope due to the limited types of noise that are actually suppressed. The noise processing circuit is typically faced with noise from a plurality of different sources. In existing protocols, cacophonies resulting from subtle changes in vehicle rhythms are often disregarded, with the noise improvement primarily focused on the intended noise source, such as a user's voice. As a result, the scope of improvements to the voice-based applications is often limited to the inflections in the user's voice, with other sources of interference disregarded. Even where existing techniques have the ability to suppress other sources of interference, the techniques typically are static in that they do not take into account the changes in the noise sources over time. These types of solutions result in a “one-size-fits-all” noise suppression scheme that fails to take into account environmental noises and sounds attributable to a specific vehicle and road type and that lack the capability to dynamically account for changes to background noise in or near real time.

### SUMMARY

Aspects of this disclosure use in-vehicle noise-pattern learning, which includes using static and dynamic in-vehicle input signals and information from multiple sources to create an in-vehicle noise pattern learning model. This model may be used to improve the performance of voice applications such as virtual assistants, hands-free calling, and in-vehicle communication, among others. Multiple input sources may include vehicle information in a calibration database, climate control signals from a cluster, vehicle control signals from a vehicle control module, climate control signals from infotainment systems or radios, road conditions from Global Positioning Systems (GPS), and application-based map data.

A variety of (multimodal) factors are considered to identify the noise type accurately and dynamically in a vehicle environment. These factors include vehicle data (e.g., audio captured by in-vehicle microphones, speed, engine revolutions-per-minute (RPM), engine temperatures, turn signals, windows up or down, sunroof open or closed, honking, etc.), and environment data (weather data, road segment roughness, road disruption score, and the like).

In one aspect of the present disclosure, a method for in-vehicle noise-pattern learning for voice applications is disclosed. The method includes embedding multimodal data from environment and vehicle data; embedding acoustic data from microphone-captured data in a cabin of the vehicle; concatenating the embeddings to form a latent vector characterizing the embeddings; estimating a mean and variance of the latent vector using an adaptive time window; and identifying a noise type using the mean and variance of the latent vector, the noise type identification being fine-grained via the adaptive time window to accurately emulate vehicle noise.

In various embodiments, the environment data includes weather data, road segment roughness, road disruption scores, or location-based application programming interfaces (APIs), and the vehicle data comprises speed, engine revolutions-per-minute (RPM), engine temperature, turn signals on or off, windows up or down, sunroof open or closed, or honking a horn in the vehicle. Further, in various embodiments, identifying the noise type includes calculating an inter-quartile range (IQR) of the mean and variance of the latent vector as measures of dispersion for both the mean and variance within a calibratable time window. The method may further include producing fine-grained noise type identification based on the calculated IQR and the adaptive time window.

In various embodiments, fine-grained noise type identification includes one or more of stationary mean and stationary variance; non-stationary mean and stationary variance; stationary mean and non-stationary variance and non-stationary mean and non-stationary variance. The adaptive time window may be based on one or more of an inverse logistic function, a reverse sigmoid function, or a combined mean IQR and variance IQR. The identified noise types may be used for in-vehicle voice applications including active noise cancellation or speech enhancement. The identified noise type may further be used for one or more out-of-vehicle applications including denoising or dereverberation.

In another aspect of the disclosure, a vehicle for in-cabin noise-pattern learning for voice applications includes a vehicle body including a cabin arranged therein; a memory; a processor coupled to the memory and configured to: embed multimodal data from environment and vehicle data; embed acoustic data from microphone-captured data in the cabin; concatenate the embeddings to form a latent vector characterizing the embeddings; estimate a mean and variance of the latent vector via an adaptive time window; and identify a noise type using the mean and variance of the latent vector, wherein the noise type identification is fine-grained to accurately emulate vehicle noise.

In still another aspect of the disclosure, a system for in-vehicle noise pattern learning for voice applications includes a vehicle body including a cabin arranged therein; a memory; a processor coupled to the memory, the processor and memory being coupled within the vehicle body, the processor being configured to: embed multimodal data from environment and vehicle data; embed acoustic data from microphone-captured data in the cabin; concatenate the embeddings to form a latent vector characterizing the embeddings; estimate a mean and variance of the latent vector via an adaptive time window and identify a noise type using the mean and variance of the latent vector, wherein the noise type identification is fine-grained to accurately emulate vehicle noise.

In various embodiments of the vehicle and system, the environment data includes weather data, road segment roughness, road disruption scores, or location-based application programming interfaces (APIs), and the vehicle data comprises speed, engine revolutions-per-minute (RPM), engine temperature, turn signals on or off, windows up or down, sunroof open or closed, or honking a horn in the vehicle. Further, in various embodiments, identifying the noise type includes calculating an inter-quartile range (IQR) of the mean and variance of the latent vector as measures of dispersion for both the mean and variance within a calibratable time window. The method may further include producing fine-grained noise type identification based on the calculated IQR and the adaptive time window.

In various embodiments of the vehicle and system, fine-grained noise type identification includes one or more of stationary mean and stationary variance; non-stationary mean and stationary variance; stationary mean and non-stationary variance and non-stationary mean and non-stationary variance. The adaptive time window may be based on one or more of an inverse logistic function, a reverse sigmoid function, or a combined mean IQR and variance IQR. The identified noise types may be used for in-vehicle voice applications including active noise cancellation or speech enhancement. The identified noise type may further be used for one or more out-of-vehicle applications including denoising or dereverberation.

The above summary is not intended to represent every embodiment or every aspect of the present disclosure. Rather, the foregoing summary merely provides examples of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes the various combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is a conceptual diagram describing techniques for dynamic in-vehicle noise pattern learning, in accordance with an aspect of the disclosure.

FIG. 2 is a conceptual diagram describing techniques for dynamic in-vehicle noise pattern learning using a sample latent vector, in accordance with an aspect of the disclosure.

FIG. 3 is a flow diagram describing techniques for mean and variance based noise type identification using inter-quartile range (IQR_{μ,σ}_{²}) designations, in accordance with an aspect of the disclosure.

FIG. 4 is a conceptual diagram describing techniques for determining an adaptive time window using inter-quartile range (IQR_{μ,σ}_{²}) designations, in accordance with an aspect of the disclosure.

FIG. 5 is a block diagram of a system for implementing the statistical noise analysis for use in voice-based applications.

The appended drawings are not necessarily drawn to scale and may present a simplified representation of various features of the present disclosure, including, for example, specific dimensions, orientations, locations, and shapes. In some cases, well-recognized features in certain drawings may be omitted to avoid unduly obscuring the concepts of the disclosure. Details associated with such features will be determined in part by the particular intended application and use case environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation,” Moreover, words of approximation such as “about,” “almost,” “substantially,” “generally,” “approximately,” etc., may be used herein in the sense of “at, near, or nearly at,” or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

For purposes of the disclosure, the terms “granularity” and “fine-grained” refer generally to the number of bits of data characterizing the time window and that represents an amount of corresponding data of similar length. The finer the grain, the more detailed the time window, and/or the changes to an adaptive time window, for a given amount of data. The data may represent acoustic noise generated by the road, for example. The time window may then represent the resolution of the acoustic noise, e.g., the number of times the noise pattern changes.

The subject matter herein describes techniques for dynamic noise pattern learning for voice applications. In the case of a vehicle, the disclosure describes using static and dynamic in-vehicle input signals and information transmitted from multiple sources to create an in-vehicle noise pattern learning model. This learning model in turn may be used to improve the performance of different voice applications using noise suppression and echo cancellation. Exemplary such applications include virtual assistants, hands-free calling, and in-vehicle communication. Multiple input sources to the learning model may include vehicle information in a calibration database, climate control signals from a cluster, vehicle control signals from a vehicle control module, climate control signals from infotainment radios, and road conditions from navigation, Global Positioning Systems (GPS), and related navigation-based data.

In one aspect, a number of different factors are considered to accurately and dynamically identify the noise type(s) present in vehicle environments, and particularly the types of noise that will adversely affect the quality of a voice transmission over smaller changing (or more finely-grained) adaptive segments of time in a voice-based application. Such factors may be categorized into vehicle data and environment data. Vehicle data may encompass a wide variety of data types. Certain nonlimiting examples of vehicle data include acoustic data (e.g., audio captured using in-vehicle microphones positioned with their respective inputs in the vehicle cabin), speed, engine rotations per minute (RPM), engine temperature, the presence or absence of turn signals, whether one or more windows are up or down, whether the sunroof is open, honking of the vehicle horn, and a large number and variety of sounds that a vehicle may independently make. One example of the latter category is whether the muffler is adequately dampening the sounds from the engine in a combustion-based vehicle. Other examples include noises made by one or more circuits or mechanical devices that have sufficient magnitude to resonate acoustically through the cabin and into the affected resource.

In addition to vehicle data, environment data may be present as noted and may adversely affect the subject voice application. Environment data may include, for example, weather data (such as more likely events like raining or thunderstorms to less likely events such as tornadoes, earthquakes, and hurricanes, and other weather-based criteria), road segment roughness, road disruption scores, shouting pedestrians or bicyclists, motorcycles sharing the road, and the like.

Aspects of the disclosure include a system having a processor, a memory for executing code, and application-based elements for running on the processor such as application programming interfaces (APIs). For purposes of this disclosure, a “processor” is construed to include one or more processors. If more than one processor is involved, they may, but need not, be identical in structure. They may run identical or different executable code and instruction sets. They may adopt identical architectures, or their architectures may be different. Non-exhaustive examples include a multiple-instruction, multiple data (MIMD) processor, or a single instruction multiple data (SIMD) processor. The processors may also be complex instruction set computer-based (CISC) processors, or reduced instruction set computer-based (RISC) processors, or some combination thereof. The processor may be customized partially or exclusively for the vehicle.

The processor may be implemented in software, hardware, or some combination thereof. For example, the processor may include a digital signal processor (DSP) for executing commands in hardware. In some embodiments, the controller and memory may be implemented within the vehicle as an Application-Specific Integrated Circuit (ASIC), a field programmable gate array (FPGA), or a system on a chip (SoC). Physically, the processor may be implemented within one or more electronic control units (ECUs) of the vehicle. The ECUs in turn may be networked or wired together under the coordination of a controller unit, such as a Controller Area Network (CAN), or which are simply hardwired together. In various embodiments, machine learning in a vehicle may be accomplished using one or more processor designs that exchange data dynamically using cloud computing. Use of a cloud platform in this context is beneficial, as vehicle products are becoming implemented increasingly via software. This trend is based in part on meeting increasing demands of customers to establish new vehicle features and enable new functions. This trend also enables manufacturers to design and build new platforms by developing code that bolsters capabilities of existing hardware quickly and efficiently. The cloud computing environment may further reduce storage costs and increase the speed of new designs by manufacturers.

It should be noted that, while use of the cloud is one method of implementing the principles of the present disclosure, the principles need not be limited to the cloud, and more traditional data-centric systems may be used in some embodiments. For example, two or more automobiles may be networked to split their processing and data-sharing resources, but without adopting a cloud platform. Further, as mentioned above, the processing and data-caching capabilities needed to execute the principles of this disclosure may be independent of a given vehicle. One or more general-purpose or dedicated processors, or an array thereof, may be used within a vehicle for implementing machine learning. Various types of computer-readable media, such as flash memory, hard disks, and the like, may be loaded onto a high speed memory. This may include code, for example, that is configured to be executed by a processor for processing incoming noise signals for use in dynamic machine learning for voice applications. The subject vehicle may communicate with one of a sequence of relevant nodes over a cellular network, such as 3G/4G/5G, or another suitable network such as a metropolitan area network (MAN), a wide area network (WAN), local area network (LAN), Bluetooth, or another network protocol.

Where the embodiments adopt a network-based approach such that the cloud is used as a computing platform, the various features and functions of the vehicle may be stored in a local memory during a machine learning session. The cloud as used herein may refer to the cloud platform specifically tailored to the vehicle's machine learning applications for noise reduction and echo cancellation. Data may be uploaded to the cloud where it may be stored until it is needed again. Likewise, data may be downloaded from the cloud when it is needed as a data input or as executable code.

During an active telephone call in a vehicle, a dedicated set of signal processing libraries may be used. For example, when the driver is using a Bluetooth device, or Android auto, and requests connection of a telephone call, a separate library may be used. When noise suppression and echo cancellation techniques are used, the outgoing signal is typically defined before it goes to the cloud during an active phone call. To maintain good performance on the call means optimizing the signal by suppressing unwanted noise and cancelling echoes. When a buffer is open and the speaker starts talking, if the ensuing noise is palatable to the human car, that means it will be ideal for the voice check engine. Conversely, if there is a great deal of static and echoes, the speech engine may struggle recognizing the words that are being articulated into the microphone.

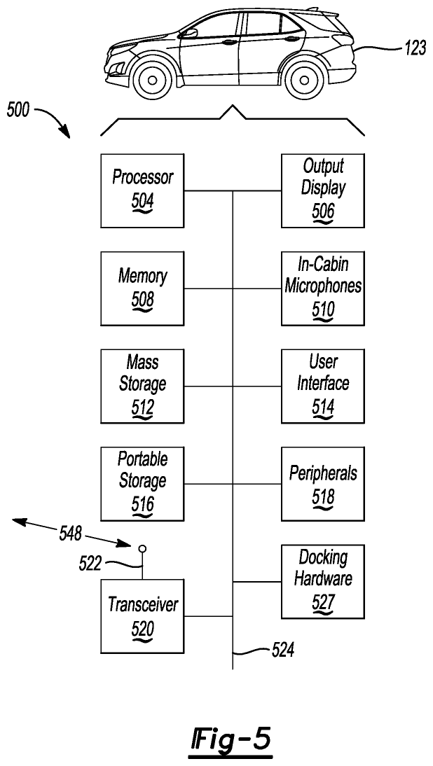

As a result, aspects of the disclosure take into account a potentially large number of data points that may give rise to even moderate vehicle noise, thereby affecting voice applications. To this end, one benefit to maintain optimal sound is that an application should be cognizant of most environmental factors affecting the vehicle's acoustics at a given moment. The more aware by the noise suppression platform of the application of factors adversely affecting acoustics in the vehicle, the more intelligent that the solution platform may eradicate these anomalies during a speech session. Because the voice suppression application is made aware of the vehicle's speed at a given moment, the application may calculate how much noise the vehicle would create in sound pressure level (SPL). In turn, using input such as the vehicle speed, the engine revolutions-per-minute (RPMs) may be calculated. The application is designed to include acoustic effects in the vehicle, such as the occurrence of a turn signal window. As described below with reference to FIG. 5, the information relevant to these types of acoustic artifacts may be available on a vehicle bus 524 for storage and processing. For example, the information may be in the form of an Extensible-Markup-Language (XML), a JavaScript Object Notation (JSON) format for representing structured and other non-acoustic data using the JavaScript object syntax, or a C-structure. The C-structure is a user-defined data type that may be used to group items of potentially different types into a single type. The above formats are exemplary in nature, and other protocols are possible. In an aspect of the disclosure, the noise suppression and echo-cancellation system uses a regression analysis using fine-grained (highly and finely adjustable) adaptive time windows to estimate the production of noise and echoes. As the data is adaptively filtered, the processor may continue to make corrective adjustments to suppress the data and cancel the echoes.

Thus, for example, the processor in the ECU evaluates the different data types over respective time windows to determine their effects, if they are present, on voice applications. When a sunroof and a left window are open, for example, the processor may use this information to obtain a better estimation of the signal-to-noise ratio (SNR) in the vehicle cabin. As another example, the processor may use recognized acoustic signatures to determine that the ventilation system is on, or that the fan is on. Based on this knowledge, the processor may make further determinations, such as whether the air from either system is oriented or directed in the driver's face. Exemplary sets of such occurrences provide the echo-cancellation element with immediate and ongoing knowledge of the acoustic artifacts that give rise to the need for echo cancellation. The fact that the noisy environment may suddenly change or morph into a different sound such that the filter constantly adapts to the sound in the new time window is an attribute of the disclosure that enables dynamic, granular noise suppression and echo cancellation based on adaptive filtering as the data stream is continually provided and changes in magnitude dynamically over time.

Different data streams may augment the adaptive filtering to enhance the overall effect. For example, in some embodiments, sensors or microphones may be embedded in posterior portions of the vehicle for the purpose of determining the type of terrain on which the vehicle is driving. Noise produced by the road-type may have a significant ongoing effect on the use of a voice application in the vehicle. In addition to this technique, the vehicle may obtain road surface data from the global positioning system (GPS) by considering the geographical relationship between two or more points. In these latter embodiments, the road information may coexist with road information stored in a computer-readable medium in different modules of the vehicle, such as a list of possible surfaces that may be encountered while the vehicle is in route to a destination. These procedures may be akin to auto-correlation metrics, where the system may change the coefficients and the metrics to reconcile the different input characteristics (e.g., the terrain gleaned from different sources like a map program and a GPS). Noises may be represented as a probability distribution, also referred to as a parametric representation of the distribution. A “Gaussian” distribution is an example of a probability distribution, which is a bell-curve displayed to include a mean u and a square of the standard deviation, or σ².

The processor may employ a regression analysis to model the relationship between a dependent variable and one or more independent variables. The regression analysis may be used to determine the strength of the correlation between the variables for modeling the future relationship between them. More fundamentally, regression analyses may be used in machine learning to predict future outcomes and analyze past outcomes. In the context of machine learning, regression may allow the system to predict a continuous outcome (such as a “y” value on a vertical axis) based on the value of “x” predictor variables.

The processor may often determine or identify relevant variables for a particular regression analysis using embeddings. Embedding various data types may also be referred to herein as “embeddings.” Various application programming interfaces (“APIs”) provided for these analyses may allow the use of embeddings to measure the relatedness of text strings and other types of data strings. An embedding is a vector (list) of numbers. The distance between two vectors measures their relation. In the example above, the processor may use a regression analysis using existing data to identify the nature of the driving surface.

As further information pertaining to vehicle operating condition, for example, the speed of the vehicle, the state of HVAC system including blower speed, number of occupants in the vehicle cabin, and other information that may be easily gleaned from the vehicle communication network, may be leveraged to build a context. This information is used to establish a regression model. Adequate amounts of training data are used for honing these regression models. This is essentially tokenization of the input feature vectors that are then converted into relevant vector embeddings by using a special Neural Network Architecture, also referred to as “transformer” models. These embeddings will lead to more accurate estimation of statistical system identification of the vehicle noise and therefore shall help in more effective fine-grained noise cancelation. When the data is ultimately converted into the relevant vector embeddings, it may be said that the data is “embed” for the input data at issue (acoustic noise, etc.) to form the embeddings, such that the term may be used in its verb or noun form.

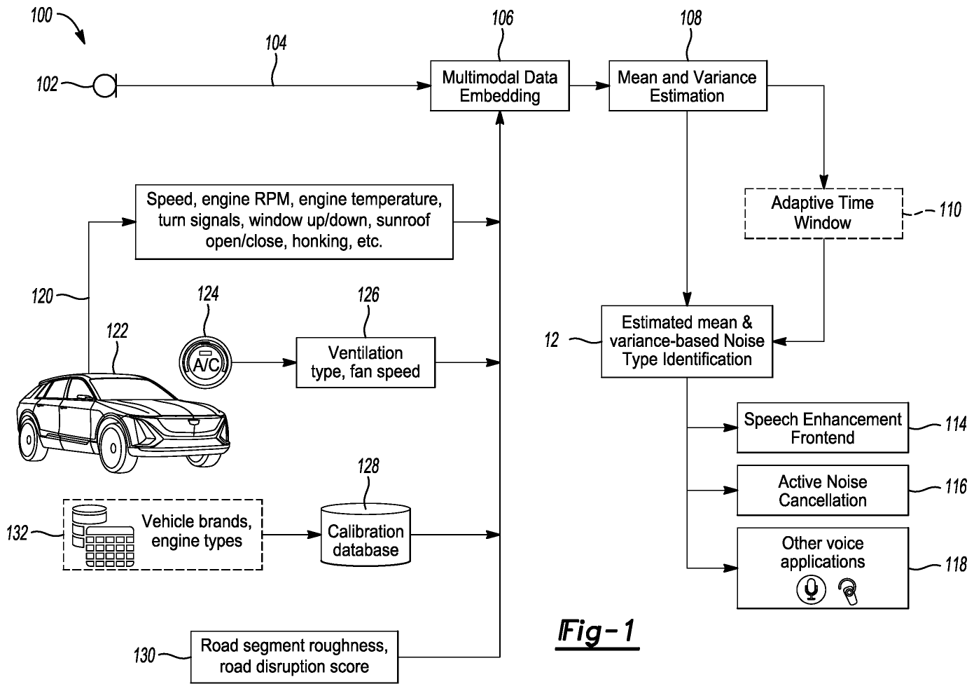

FIG. 1 is a conceptual diagram 100 describing techniques for dynamic in-vehicle noise pattern learning, in accordance with an aspect of the disclosure. The techniques describe a solution for Dynamic Noise Pattern Learning that is implemented partly in the vehicle, and in one embodiment, partly in a cloud for storing dynamic libraries. As noted, the cloud need not be used in the technique, as other storage media may instead be used locally in the vehicle or another networked location.

With continued reference to FIG. 1, data relevant to the application at issue may be derived from several sources. Acoustic data, such as the cabin noise and the voice of the user, may be derived from one or more microphones 102 distributed as inputs at strategic locations in the vehicle cabin and channeled via respective vehicle wires 104 (of which one is shown) to a source of multi-modal data embeddings. Examples may include vehicle data 120 from vehicle 122 including speed, engine revolutions-per-minute (RPM), engine temperature, turn signals, window positioning (up versus down), sunroof positioning (open versus closed), honking, and the like. As another example, an HVAC or air conditioning system 124 may control various other related acoustic phenomena such as ventilation type or fan speed 126. Further, noise specific to the vehicle brand and type of engine 132 may be regularly stored in a calibration database 128 and retrieved when needed. External environment data including road segment roughness and road disruption score 130 may be provided.

An embedding in the context of machine learning is a mapping or converting of high-dimensional data into low-dimensional data, typically in the form of a vector having characteristics that relate to the embedded data. Stated differently, a data embedding is a generally dense numerical representation of data, expressed as a vector. The set of vectors formed quantifies the similarities between categories.

The data in multimodal data embedding block 106 learns the representation or converts high-dimensional multimodal data (e.g., acoustic data, vehicle signals, fan speed, calibration database, etc.) to a single low-dimensional vector space. This allows for more efficient and effective machine learning tasks, such as classification, clustering, and retrieval. Different approaches may be used to multimodal data embedding such as convolutional neural networks (CNNs), recurrent neural networks (RNNs) long short-term memory (LSTM) and geometric machine learning techniques.

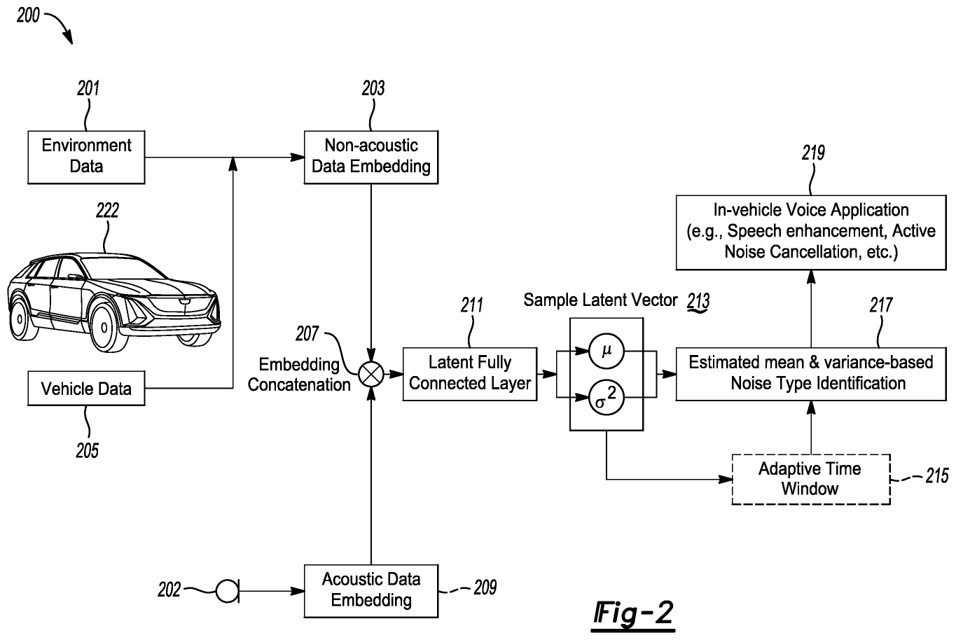

In addition, as described further in FIG. 2, the embeddings in multimodal data embedding block 106 may be used to represent the applicable noise type as a parametric vector. For system identification, the noise may be represented as a vector of parameters.

Thus, in multimodal data embedding, collective data from a large number of influential data sources may be embedded. The multimodal nature of the data embedding may significantly increase the accuracy of the machine learning by providing a more realistic and inclusive set of factors that otherwise would add noise and adversely affect the use of voice applications.

Once the initial estimate of the mean and variance at logic block 108 for particular types of noise is determined to statistically represent the noise as a probability density function, the processor may use the accrued data in adaptive time window 110, the processor may perform a time window based analysis to gauge the statistical properties of the noise, at logic block 12. Once the processor determines this classification at 12, the noise suppression and echo cancellation may be performed in a more accurate and effective way. For example, the newly classified data in 12 may be used in the application at issue to enhance the user speech at the front end of the vehicle (114), it may be used for active noise cancellation (116), or it may be used to cancel or augment acoustical signatures in the context of other voice applications (118).

Two significant advantages of the system in FIG. 1 over existing approaches include that first, the types of relevant data are substantially increased into a sophisticated multimodal embedding (106). “Sophisticated” refers to the fact that a plurality of sources of noise are taken into account in the machine learning model, which in turn increases the accuracy and precision of the result. Second, the data may be used to enhance a wide body of applications, using more realistic models to accomplish noise suppression and cancelling, where warranted. Third, the wide amount of acoustic and non-acoustic data that may be processed means that more user applications may benefit from the initial data analysis.

FIG. 2 is a conceptual diagram describing techniques 200 for dynamic noise pattern learning in a vehicle 222 using a sample latent vector 213, in accordance with an aspect of the disclosure. While FIG. 1 conveys a higher-level illustration of the system components and a description of various embodiments, FIG. 2 provides more granular details of parametric estimation according to an embodiment. For example, FIG. 2 adds the embedding concatenation 207 embodiment that is not explicitly shown in FIG. 1. FIG. 2 shows the relevant data in the context of environment data 201 and vehicle data 205. As noted, factors that are needed to identify the noise type accurately and dynamically in vehicle environments include vehicle data 205. In short, in FIG. 2, the processor scans a plurality of data parameters to define a distribution of data as a mean μ and a variance σ². Examples of vehicle data include audio captured by in-vehicle microphones, speed, engine RPMs, engine temperature, whether a turn signal is active, the up/down nature of the windows, the opened/closed nature of a sunroof, honking, and the like. Examples of environment data 201, by contrast, may include weather, road segment roughness, and road disruption scores. Data embedding as shown, for example, in logic blocks 203 and 209, is a technique for representing data as points in an n-dimensional space such that similar data points cluster together. As noted, embedding in general is a low-dimensional representation of higher dimensional data. Microphones 202 may be positioned in the cabin to produce acoustic data, which is combined or reconciled with the remaining acoustic data from sources outside the cabin.

Referring still to FIG. 2, the idea of non-acoustic data embedding 203 is derived from supervised or unsupervised representation learning techniques. This process may also be generally referenced as parametric presentation distributions. Non-acoustic data includes not only structured text data, but also includes time series data such as vehicle dynamic data (vehicle data that changes over time). FIG. 2 shows the embedding concatenation 207 between the acoustic data embedding 209 and the non-acoustic data embedding 203. Embedding concatenation involves combining the generated embeddings into a single embedding. This may be done by simply concatenating the vectors representing the embeddings, or by using a more sophisticated method, such as weighted averaging. Once the non-acoustic data embedding 203 is concatenated with the acoustic data embedding 209, the resultant feature vector is passed to a latent fully connected layer 211 to estimate the mean μ and variance σ². The processor may use a deep learning mechanism in A.I. to determine a distribution. The distribution is represented by sample latent vector 213. That is, sample latent vector 213 is a calculation of the initial value of that distribution. In this example, sample latent vector 213 may be considered as an area having two values—the mean μ and variance σ². The mean μ and variance σ² of sample latent vector 213 may then be used by the processor to identify the noise type over the adaptive time window 215, as shown in logic block 217. For example, noise identification uses mean μ and variance σ² noise during the applicable adaptive time window 215 to align the data temporally and accurately identify the noise type. Using a fine-grained adaptive time window that may quickly change width over time in small or large increments, as here, is contrary to existing implementations in vehicle noise suppression, the latter of which often use fixed time window sizes. These existing prediction methods, however, are imprecise because, unlike the adaptive time window disclosed herein, the fixed time window is not adjusted to reflect more recent trends in the data. Examples of the need for an adaptive time window includes changing road conditions, and many others, including changing trends in input data in general.

In the example of changing ambient or road noise, this time changing may be very rapid. Here, the adaptive time window 215 allows the system to use a first timing window to detect what type of noise/ambient noise is present. The processor may use that first timing window to collect the noise samples, and then estimate the mean and variance based noise type identification, as in logic block 217. The smaller the time window, the more accurate the noise predictions. If the processor is computationally efficient enough, the processor may select time samples of almost arbitrarily small length, which increases the accuracy of the distribution and thus the effectiveness of noise cancellation. Noise estimation is a statistically multivariate problem in which the system is incorporating multivariate inputs. At the same time, the physical conditions giving rise to these variables are changing. As an example, in a vehicle, the turn signal may be suddenly activated, a person may cough, the wind may start blowing, the window wipers may be turned on, the raindrops may fall on the windshield, etc. Each of these events may be considered, and treated as, distributions having individually adaptive time windows.

Referring still to FIG. 2, the identified noise type may be used later as an enabler in different in-vehicle voice applications 219 that need information about the noise type, such as speech enhancement modules and active noise cancellation, for example.

As described further herein, the principles of the disclosure enable dynamic, fine-grained machine learning of voice patterns while a vehicle is being driven. Real-time noise patterns may then be applied to different voice applications. Mimicking road noise and other acoustic and non-acoustic artifacts with a “one size fits all” approximation, as is presently performed, often does not give rise to accurate results. As shown in FIG. 2, both acoustic and non-acoustic data may be embedded (logic blocks 203, 209) using geometric deep learning to form a latent vector that includes an estimate of the mean μ and variance σ² using the relevant time window 215 to account for the dynamic or changing nature of the input data. That is, once the processor performs an initial estimate of the mean μ and variance σ² in order to represent the noise statistically as a probability function, the processor may use the time window-based analysis 215 to further gauge the statistical properties of the noise at different periods in time, such as is performed in logic block 217.

After the processor uses the statistical properties of the mean μ and variance σ² during the applicable time window to identify the noise type (logic block 217), the determined statistical noise data may then be used in an in-vehicle voice application, such as, by way of example, a speech enhancement, active noise cancellation, etc. and similar techniques to suppress noise dynamically and cancel echoes, as in logic block 219. These applications may further be used as inputs to other voice-based applications to improve their overall performance.

It should be noted that the non-acoustic data embedding 203, the acoustic data embedding 209, and the embedding concatenation 207 produce a fully connected layer 211 that enables a sample latent vector 213 to incorporate the relevant data types needed to accurately compute the distribution of noise for correction and enhancement purposes. Prior approaches that fail to account for various types of data are less accurate, or inaccurate, as a result.

In another aspect of the disclosure, a technique for estimating the mean μ and the variance σ² is disclosed. Four different noise types may be automatically determined based on an interquartile range (IQR) of the estimated mean and the variance as a measure of dispersion. The IQR is a measure of statistical dispersion. Dispersion, in turn, is a measure of the spread of a distribution of data. IQR dispersion is defined as the difference between the 75^{th} and 25^{th} percentiles of the data. In the example of the Gaussian waveforms discussed above, two such waveforms may share the same mean but may be distributed over a larger or smaller time window. Where a waveform has a small amount of dispersion, the waveform tends to peak at a point and rapidly fall to zero or some negligible value on either side of the peak. By contrast, a waveform having a larger dispersion means that the data is spread over a larger time window. IQR is a means of describing a magnitude of this dispersion using four different quadrants, as discussed further below. Beneficially, the processor may achieve fine-grained noise type identification based on the calculated IQR and an adaptive time window. The noise types as further described below include stationary mean and stationary variance; non-stationary-mean and stationary variance; stationary mean and non-stationary variance; and non-stationary mean and non-stationary variance.

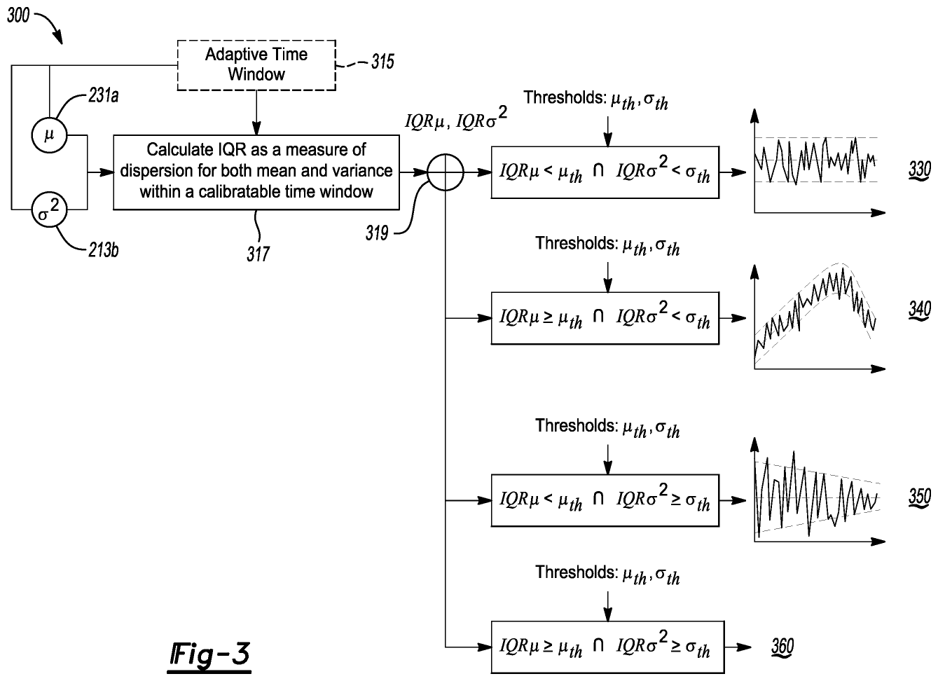

FIG. 3 is a flow diagram 300 describing techniques for mean and variance based noise type identification using IQR designations, in accordance with an aspect of the disclosure. FIG. 3 shows techniques for estimating mean and variance of a collection of input data and then using an IQR technique to determine a noise type. For purposes of the disclosure, the noise type outcome may be synonymous with the noise type when an IQR model is used. FIG. 3 illustrates the interquartile ratio of the mean μ 231a and the interquartile ratio of the variance σ² 213b within a target threshold. In some cases, either the mean μ 231a or the variance σ² may be stationary by itself, or both values may be stationary. FIG. 3 shows adaptive time window 315 used in FIGS. 2 and 3, as well as mean μ 231a and variance σ² 213b to calculate the IQR as a measure of dispersion for both the mean μ 231a and the variance σ² 231b within a calibratable (e.g., a finely-grained and dynamically adaptable) time window, as in logic block 317.

In logic block 319, the u-based IQR (IQR_{μ}) and the 62-based IQR (IQR_{σ2}) values are compared with four possible thresholds characterized by noise type outcome 330, 340, 350 and 360. In outcome 300, both IQR_{μ} and IQR_{σ2} are determined to be less than the respective target thresholds μth and σth, resulting in a curve with a stationary mean and a stationary variance, as shown by the graph corresponding to outcome 330. In outcome 340, just IQR_{μ} exceeds its target threshold μth, resulting in this example in a curve with a non-stationary mean and a stationary variance. Referring to outcome 350, just variance IQR_{σ2} exceeds its target threshold σth, resulting in a curve having a stationary mean but a non-stationary variance, as shown in the graph corresponding to outcome 350 in FIG. 3. Referring to outcome 360, both IQR_{μ} and IQR_{σ2} are greater than their respective thresholds μth and σth, and no graph results. Various levels of predictability may be determined depending on the quartile or outcome of the different comparisons.

In short, the embodiment of FIG. 3 uses the four different types of noise to estimate the mean and the variance. As noted, based on the adaptive time window, the noise signature changes. As an example, if the signature has a constant mean, a constant variance outcome is a straightforward scenario. However, where the standard deviation (and hence the variance) is changing or the mean is changing, those two patterns may be distributions by themselves and which both should be accounted for, as illustrated in outcomes 340 and 350, respectively.

Using the estimated mean and variance and comparing whether they exceed a threshold in a designated quartile, the noise type with the applicable characteristics of mean and standard deviation, and accurate distributions, may be identified.

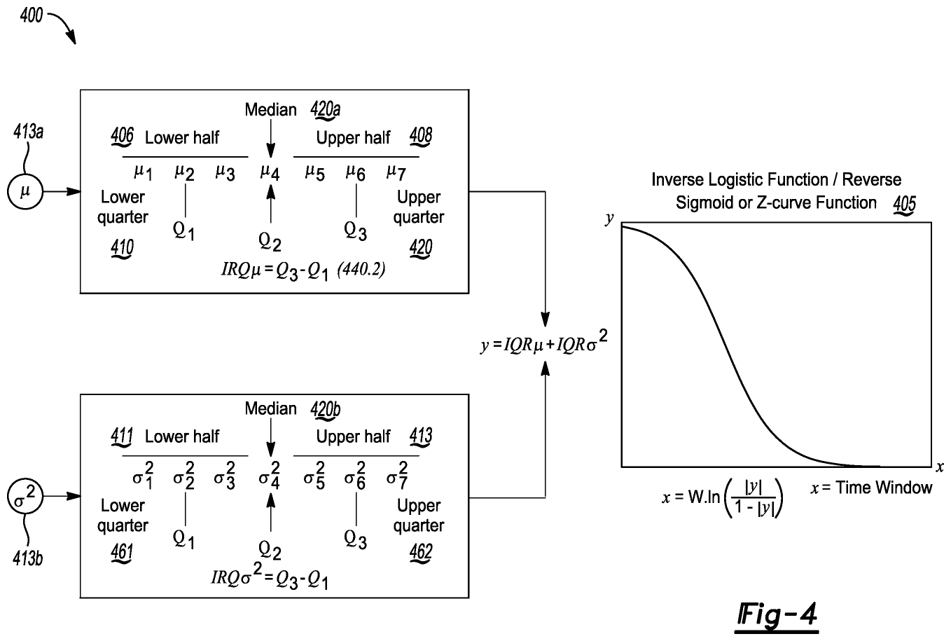

FIG. 4 is a conceptual diagram 400 describing techniques for determining an adaptive time window, in accordance with an aspect of the disclosure. An IRQ range is a measurement of where the most values in a data graph lie. The processor takes the mean 413a and variance 413b calculated from the embodiment in FIG. 3 in each quarter of the IRQ to produce an Inverse Logistic Function, Reverse Sigmoid, or Z-curve Function (“function”) 405. The IQR divides the data into quarters, where the lowest quarter of the IQR includes the smallest quarter of values in the input data and the upper quarter includes the highest quarter of values, with the two intermediary quarters including the middle half portion of the data.

In the function 405, the y axis represents the sum of IQRμ and IQRσ² values obtained from the IRQ analyses in boxes 420a and 420b. Each of boxes 420a and 420b represents an adaptive time window. Box 420a takes input mean μ 413 as an input, with a spread of mean values defined by lower half 406 and upper half 408. The lower half 406 includes mean values μ1-μ3 and the upper half 408 includes mean values μ5-μ7. The lower quarter 410 corresponds to a Q1 of μ2, and the upper quarter 420 corresponds to a Q3 of μ6. Thus IQR_{μ}=Q3-Q1 from equation 440.2. Referring to box 420b in which median σ² 413 is input, a similar analysis yields IQR_{σ}_{²}=Q3-Q1 where lower half 411 includes σ²₁-σ²₃ and upper half 413 includes σ²₅-σ²₇. In this case, the lower quarter 461 corresponds to a value of σ²₂ and the upper quarter 462 corresponds to a value of σ²₆. Thus, the sum y=IQR_{μ} and IQR_{σ}_{²} from boxes 420a and 420b represent the y axis of the function 405. The x axis of the function 405 represents the applicable time window. The time window may be calculated using:

$$x = Wln \frac{\vert y \vert}{\vert y + 1 \vert}$$

where W is a predefined window value and y is the value computed above for the y-axis. It should be noted for clarity that in the box 420, the median value corresponds to a mean of Q2=μ₄. Likewise, in the box 420b, the median value corresponds to a median of Q2=_{σ}_{²}_{₄}.

Summarizing FIG. 4, the processor retrieves the mean and variance calculated from FIG. 3 within each quarter of the IQR. The function 405 is consistent with the rate of change or first derivative of the data. Thus, real time input values are input, and a non-negative derivative value should result at each inflection point. This technique is consistent with a sigmoid or cost function. Because one objective is to understand the distribution pattern, the sigmoid function may be used to define the distribution of the mean or the distribution of the standard variation in cases where the two are not stationary.

FIG. 5 is a block diagram of a system 500 for implementing the statistical noise analysis for use in voice-based applications. The system and apparatus of the disclosure may be implemented in a vehicle 123. In various configurations, when the cloud is used to provide data and code to the vehicle via an appropriate network, the apparatus may work as a system that includes the vehicle 123 and a remote cloud. In some embodiments, the system may be implemented on more than one vehicle.

Within the vehicle 123, it was noted that the term processor 504 may itself refer to one or more processors within one or more computing devices. Such computing devices may include a motherboard of a computer, for example, or an electronic control unit (ECU) or Automotive microcontroller unit (MCU) within the vehicle 123. Depending on the architecture of the vehicle and its electronic configuration, the ECU and/or MCU may include the processor 504 as well as memory 508 (such as cache memory, dynamic random access memory (DRAM), static random access memory (SRAM) or the like). In other cases, the ECU (or MCU) is maintained separately from these components and where applicable, the ECU or MCU may be hardwired to these components.

The mass storage 512 may include a magnetic disk drive, a solid state disk drive, or another form of non-volatile memory and may be used to retrieve data from the cloud via an antenna 522 over a suitable network 548 and under the control of processor 504. Referring back to processor 504, this component may broadly be construed to include a variety of different processing devices. For example, the processor 504 may be a multi-purpose microprocessor (or a plurality thereof). In other embodiments, processor 504 may be a digital signal processor (DSP), an application specific integrated circuit (ASIC) (which may embed within it other devices shown in this Figure), a field programmable gate array (FPGA), a system-on-a-chip (SoC), or other processors or arrays thereof. Different processors within processor 504 may perform specific functions of the techniques disclosed herein.

Referring again to the memory 508, the memory 508 may be DRAM or another faster memory upon which executable code corresponding to active applications may be loaded, or upon which useful data may be loaded. Portable storage 516 may include a removeable storage such as a flash memory or USB drive. Portable storage 516 may include firmware or a means to upload firmware to processor 504. Output display 506 may include the display panel(s) on the dashboard of the vehicle, such as one or more I/O touchpads characterizing an infotainment system or a navigation system. Output display 506 may enable a user to control settings corresponding to the techniques herein. In addition, vehicle 123 may include one or more in-cabin microphones 510. If a plurality of microphones 510 are used, they may be positioned in various parts of the interior of the vehicle such that the acoustic input of the microphone may capture sounds made by the vehicle 123 or its occupants as efficiently as possible. A user interface 514 may also be included. The user interface 514 may represent corresponding displays embedded as part of the output display 506, or they may include switches, buttons, and other control features built into the dashboard for the user (or a professional car dealer) to interface or interact with the algorithms executed in processor 504 and perform other functions relevant to the system. Various peripheral equipment 518 may also be used in connection with the system, such as Bluetooth devices, radios, or peripheral controls for performing various functions. Examples may include increasing the granularity of the machine learning or adjusting other controls relating to similar functions, although these types of controls may also be implemented using the network 548, antenna 522, and transceiver 520 under control of processor 504 (such as in firmware updates or responses to ECU network requests). Alternatively, these functions may be controlled by the user interface 514. In addition, to the extent that the apparatus including one or more of the identified elements in vehicle 123 are externally added to the vehicle (e.g., during the course of upgrading older vehicles, etc.), docking hardware 527 may be provided, such as under the dashboard or in another accessible area, to enable the vehicle 123 to be modified to perform one or more of the herein-described techniques.

Benefits of the techniques described herein are extensive. Unlike in existing implementations, the multimodal data embedding and embedding concatenation techniques may dramatically improve the accuracy of the machine learning process by providing data relating to a large number of phenomena, acoustical and non-acoustical, vehicle and environmental, that otherwise would affect adversely the performance of a voice application. The latent parameter estimation provides efficiency and enables the multiple forms of data to be converted numerically for subsequent efficient processing. Further, the IQR-based noise type identification considers an essentially complete set of scenarios depending on whether the mean and variance factors characterizing a noise distribution are active or stationary. The techniques may also be performed using real-time vehicle control information, allowing the benefits to be fully available even when the vehicle is in motion. The techniques are also widely applicable to different voice applications including but not limited to virtual assistants, in-car communication (e.g., allowing users to convey information more clearly and with less noise to other users in the vehicle, which may be particularly useful in larger vehicles with multiple rows of seats, or in trucks), and hands-free calling.

Further, the adaptive nature of the time window enables the machine learning process to have a very high temporal resolution, resulting in very accurate computations of expected noise and interference. In providing this greater resolution, the techniques may improve user experience with voice applications and notice a visible change in performance for the better. The IQR nature of the estimated mean and variance enables the identification of different noise pattern/types.

It should also be noted that the identified noise types need not only be used for different in-vehicle voice applications such as active noise cancellation and speech enhancement. The identified noise types may also be used for different out-vehicle voice applications such as denoising, dereverberation for better performance of exterior voice assistance, and the like.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method for in-vehicle noise-pattern learning for voice applications, comprising:
embedding multimodal data from environment and vehicle data;
embedding acoustic data from microphone-captured data in a cabin of the vehicle;
concatenating the embeddings to form a latent vector characterizing the embeddings;
estimating a mean and variance of the latent vector using an adaptive time window; and
identifying a noise type using the mean and variance of the latent vector, the noise type identification being fine-grained via the adaptive time window to accurately emulate vehicle noise.

2. The method of claim 1, wherein:
the environment data comprises weather data, road segment roughness, road disruption scores, or location-based application programming interfaces (APIs), and
the vehicle data comprises speed, engine revolutions-per-minute (RPM), engine temperature, turn signals on or off, windows up or down, sunroof open or closed, or honking a horn in the vehicle.

3. The method of claim 1, wherein identifying the noise type comprises calculating an inter-quartile range (IQR) of the mean and variance of the latent vector as measures of dispersion for both the mean and variance within a calibratable time window.

4. The method of claim 3, further comprising producing fine-grained noise type identification based on the calculated IQR and the adaptive time window.

5. The method of claim 4, wherein fine-grained noise type identification comprises one or more of stationary mean and stationary variance; non-stationary mean and stationary variance; stationary mean and non-stationary variance; or non-stationary mean and non-stationary variance.

6. The method of claim 4, wherein the adaptive time window is based on one or more of an inverse logistic function, a reverse sigmoid function, or a combined mean IQR and variance IQR.

7. The method of claim 1, wherein the identified noise types are used for in-vehicle voice applications including at least one of active noise cancellation or speech enhancement.

8. A vehicle for in-cabin noise-pattern learning for voice applications, comprising:
a vehicle body including a cabin arranged therein;
a memory;
a processor coupled to the memory and configured to:
embed multimodal data from environment and vehicle data;
embed acoustic data from microphone-captured data in the cabin;
concatenate the embeddings to form a latent vector characterizing the embeddings;
estimate a mean and variance of the latent vector via an adaptive time window; and
identify a noise type using the mean and variance of the latent vector, wherein the noise type identification is fine-grained to accurately emulate vehicle noise.

9. The vehicle of claim 8, wherein:
the environment data comprises weather data, road segment roughness, road disruption scores, or location-based application programming interfaces (APIs), and
the vehicle data comprises speed, engine revolutions-per-minute (RPM), engine temperature, turn signals on or off, windows up or down, sunroof open or closed, or honking a horn in the vehicle.

10. The vehicle of claim 8, wherein the processor is configured to identify the noise type using an inter-quartile range (IQR) of the mean and variance of the latent vector as measures of dispersion for both the mean and variance within a calibratable time window.

11. The vehicle of claim 10, wherein the processor is further configured to produce a fine-grained noise type identification based on the calculated IQR and the adaptive time window.

12. The vehicle of claim 11, wherein the fine-grained noise type identification comprises one or more of stationary mean and stationary variance; non-stationary mean and stationary variance; stationary mean and non-stationary variance; or non-stationary mean and non-stationary variance.

13. The vehicle of claim 11, wherein the adaptive time window is based on one or more of an inverse logistic function, a reverse sigmoid function, or a combined mean IQR and variance IQR.

14. The vehicle of claim 8, wherein the identified noise type is used for in-vehicle voice applications including at least one of active noise cancellation or speech enhancement.

15. A system for in-vehicle noise pattern learning for voice applications, comprising:
a vehicle body including a cabin arranged therein;
a memory;
a processor coupled to the memory, the processor and memory being coupled within the vehicle body, the processor being configured to:
embed multimodal data from environment and vehicle data;
embed acoustic data from microphone-captured data in the cabin;
concatenate the embeddings to form a latent vector characterizing the embeddings;
estimate a mean and variance of the latent vector via an adaptive time window; and
identify a noise type using the mean and variance of the latent vector, wherein the noise type identification is fine-grained to accurately emulate vehicle noise.

16. The system of claim 15, wherein:
the environment data comprises weather data, road segment roughness, road disruption scores, or location-based application programming interfaces (APIs), and
the vehicle data comprises speed, engine revolutions-per-minute (RPM), engine temperature, turn signals on or off, windows up or down, sunroof open or closed, or honking a horn in the vehicle.

17. The system of claim 15, wherein the processor is configured to identify the noise type using an inter-quartile range (IQR) of the mean and variance of the latent vector as measures of dispersion for both the mean and variance within a calibratable time window.

18. The system of claim 17, wherein the processor is further configured to produce a fine-grained noise type identification based on the calculated IQR and the adaptive time window.

19. The vehicle of claim 18, wherein the fine-grained noise type identification comprises one or more of stationary mean and stationary variance; non-stationary mean and stationary variance; stationary mean and non-stationary variance and non-stationary mean and non-stationary variance.

20. The vehicle of claim 15, wherein the identified noise type is used for one or more out-of-vehicle applications including denoising or dereverberation.
